(19) United States
(12) Patent Application Publication
(10) Pub. No.: US 2017/0291361 A1
(43) Pub. Date: Oct. 12, 2017

(54) METHODS FOR PREPARING AND ORIENTATING BIOPOLYMER NANOFIBRES AND A COMPOSITE MATERIAL COMPRISING THE SAME

(71) Applicant: Mohammad Raoufi, (US)

(72) Inventors: Dorothea BRÜGGEMANN, Bremen (DE); Jan-Henning DIRKS, Bremen (DE); Mohammad RAOUFI, Tehran (IR); Joachim P. SPATZ, Stuttgart (DE)

(21) Appl. No.: 15/516,396

(22) PCT Filed: Oct. 2, 2015
(86) PCT No.: PCT/EP2015/001942

§ 371 Date: Apr. 1, 2017

(30) Foreign Application Priority Data
Oct. 2, 2014 (EP) 14003414.1

(51) Int. Cl. B29C 67/00; C08J 5/00; B33Y 80/00; D01D 5/00; B33Y 10/00

(52) U.S. Cl. CPC B29C 67/0074; D01D 5/00; B33Y 10/00; B33Y 80/00; C08J 5/005

(57) ABSTRACT

Methods for preparing and orientating nanofibers and a composite material including the same. Some methods for preparing a composite material with orientated nanofibers may include providing a nanoporous material; dissolving a natural or synthetic polymer, —in a solvent; pressing or drawing the polymer solution through pores of the nanoporous material whereby nanofibers are formed within said material; mixing the nanofibers with a matrix material; orientating or partially orientating the nanofibers within the matrix material by applying an electric and/or magnetic field; depositing the nanofibers-matrix mixture with the orientated or partially orientated nanofibers onto a substrate surface. The nanofibers may be oriented locally different in various areas/layers of the composite material, resulting in a composite material with locally independent mechanical properties.

### BACKGROUND OF THE INVENTION

The mechanical properties of fibrous composite materials are strongly affected by the volume and orientation of individual fibers. In many biological composite materials, such as insect cuticle, the orientation of nanofibers is controlled on a micro- or even nanoscale. This allows to grow materials with highly controlled and “local” mechanical properties. By gradually varying the orientation or volume of the fibers even very smooth and controlled mechanical gradients can be created within a single bulk material. Such properties are highly desirable for artificial composite materials in many fields of application.

However, with the methods for preparing biopolymer nanofibers and fibrous composite materials it is not possible to fulfill all the requirements for obtaining such artificial composite materials with locally controlled mechanical properties.

The most important requirements are:
Large quantities of fibers with a controlled diameter and length
Control of the fiber orientation independent from the composite “matrix” on a small scale.

Thus, main objects of the present invention are to provide methods for preparing and orientating polymer, in particular biopolymer, nanofibers which overcome the drawbacks of the prior art and enable to fabricate improved composite materials with locally controlled mechanical properties.

These objects are achieved according to the present invention by providing the methods of claims 1 and 7 as well as the composite material of claim 18. More specific embodiments of the invention are the subject of further claims.

### DESCRIPTION OF THE INVENTION

The method of the invention for preparing nanofibers comprises at least the following steps:
a) providing a nanoporous material, in particular a nanoporous membrane or mesh;
b) dissolving a natural or synthetic polymer in a suitable solvent;
c) pressing or drawing the polymer solution through the pores of the nanoporous material whereby nanofibers are formed within said material;
d) optionally separating the nanofibers from the solvent.

Preferably, the polymer used in the method of the present invention is a protein or a polysaccharide.

The term “protein” as used herein encompasses any sequence of more than about 10 amino acids, typically a sequence of about 10 to 1000 amino acids.

The term “polysaccharide” as used herein encompasses any sequence of more than about 10 monosaccharides, typically a sequence of 10 to 1000 monosaccharides (which may be different or identical). The monosaccharide basic units may comprise 3-9 carbon atoms, preferably 5-7 carbon atoms. The monosaccharide units may be, e.g., selected from the group comprising glucose, galactose, glucosamine, galactamine, gluconic acid, galacturonic acid, acetyl glucosamine, arabinose, fructose, fucose, mannose, rhamnose, sialic acid and derivatives thereof.

Specific, but not limiting examples of the polymer are fibronectin, elastin, fibrinogen, collagen, myosin, actin, BSA, α-actinin, laminin, chondroitin sulfate, hyaluronan, chitin-derivatives (e.g. chitosan) and mixtures thereof.

According to the present invention, a nanoporous material is used to produce nanofibers by a template-assisted extrusion process. Typically, the nanoporous material is a membrane or mesh, preferably a membrane.

The nanoporous material may be, e.g., anodic aluminum oxide (AAO), titanium dioxide, silicone dioxide, polycarbonate (PCTE), or a zeolite.

Typically, the nanoporous material has a mean pore size in the range from 4 nm to 900 nm, preferable from 100 nm to 200 nm, and a thickness in the range from 10 μm to 100 μm, preferably from 30 μm to 50 μm.

In an especially preferred embodiment, the membrane is an anodic aluminum oxide (AAO) membrane.

Nanoporous AAO membranes are chemically stable, bioinert and biocompatible and have highly ordered, self-organized nanochannels with regular pore size, uniform pore density and high porosity over a large scale. Pore diameters between 4 nm and several hundred nanometer can be achieved using an efficient, low-cost anodisation process with polyprotic acids, such as sulphuric or oxalic acid (e.g. A. Huczko, in Appl. Phys. α-Mater 70, 365-76).

Ordered AAO nanopores have been used as template materials to prepare vertical nanowires and nanoparticle arrays from various materials such as metals, semiconductors or synthetic polymers (e.g. G. Schmidt in J. Mater. Chem. 12, 1231-1238).

According to the present invention, a polymer, such as a protein or polysaccharide or a mixture thereof, is dissolved in a suitable physiological or non-physiological organic or inorganic solvent.

The solvent is not critical and a suitable solvent for a specific polymer can be easily selected by the skilled artisan using his general knowledge and/or routine experiments.

More specifically, the solvent may be selected from the group comprising acetic acid or ionic liquids (in particular for polysaccharides) or physiological buffers (in particular for proteins). Additional components (proteins, polysaccharides, nanoparticles, fluorescent or magnetic labels, etc.) can be added to the main component.

The polymer-solvent mixture is pressed or drawn (sucked) through the nanoporous material, preferably a membrane (such as anodic aluminum oxide, AAO) using controlled speed and pressure and nanofibers form at the pores of the membrane and are extruded.

For further processing, the nanofibers are usually separated from the solvent (by means of evaporation, centrifugation, sedimentation or any other suitable method of the art) and, if desired, can be further functionalised or purified.

According to the method of the invention for preparing a composite material with orientated nanofibers, the nanofibers, in particular nanofibers obtained with a method as described above, are first mixed with a matrix and converted into a desired form, such as into a 3D printable form (filament, powder, gel, etc.).

The nanofibers used for preparing the composite material typically have a length in the range from 100 nm to several millimeters, preferably from 1 μm to 5 mm and a diameter between typically 5 nm and 500 nm. Bundles of nanofibres used for preparing the composite material typically have a length in the range from 100 nm to several millimetres, preferably from 1 μm to 5 mm and a diameter between typically 1 μm and 10 μm. Such nanofibers and bundles thereof are obtainable by the extrusion method of the present invention.

Principally, the matrix material is not especially limited and may be any material, in particular any polymer, which allows to disperse the nanofibers therein.

More specifically, the matrix may be a material commonly used for 3D printing.

In particular, the matrix material may be selected from the group comprising polylactic acid (PLA), poly(lactic-co-glycolic acid) (PGLA), polyethylen glycol (PEG), polyethylen oxide (PEO), acrylnitril-butadien-styrol (ABS), polyvinyl pyrrolidone (PVP), polyvinyl alcohol (PVA), polycarbonate (PC), nylon, acrylnitril-styrol-acrylester (ASA), silicone.

An electric and/or magnetic field is used to locally and independently orientate the nanofibers within the matrix in 2D or 3D.

In a next step, the nanofibers-matrix mixture with the orientated or partially orientated nanofibers is deposited onto a substrate surface.

The material of the substrate surface is not critical and may be selected from a wide range of organic and inorganic materials, including metals, Si, SiO_{2,} metal oxides, glass, polymers etc.

The deposition of the nanofibers-matrix-mixture may be affected by any method known in the art which allows to deposit the respective form of mixture, such as gel powder etc., precise and effectively on a desired area of a substrate surface.

In a preferred embodiment of the invention, the deposition of the nanofibers-matrix mixture onto a substrate surface is affected by a deposition means (e.g. a nozzle) of a printing device. Any known method of printing, in particular 3D printing, may be used, including polygraphic techniques and multi-jet-modeling.

The method of the present invention is particularly advantageous in that different nanofibers-matrix mixtures or nanofibers-matrix mixtures with varying orientation of the nanofibers can be deposited simultaneously or subsequently on various areas of the primary substrate surface or the substrate surface already covered with a layer of the nanofibers-matrix mixture.

Thus, it is possible to orientate the nanofibers locally different in various areas of the composite material resulting in a composite material with locally independent mechanical properties. Further, this approach facilitates controlled crosslinking of the matrix on a small scale, if desired.

In a preferred embodiment of the invention, a multi-layered hierarchical composite material is printed layer by layer (3D printing) onto a substrate surface and the nanofibers are oriented locally different in various layers of the composite material and/or in various areas of one layer of the composite material.

The method of the invention may further comprise a step of heating the nanofibers-matrix before and/or while orientating the nanofibers, e.g. within the printing nozzle.

Further, the method of the invention may include a step of curing the deposited (e.g. printed) composite material for preserving the material's structure. The curing may involve a crosslinking step, typically induced by a stimulus such as electromagnetic radiation, in particular UV light, or chemical crosslinking (for polymers, etc.). For this purpose, the nanofibers-matrix mixture may comprise crosslinkable components or functional groups as known in the art.

Summarizing, the method of the invention provides several important advantages over the prior art:

1. Length and diameter of the nanofibers are fully controllable using the extrusion setup. The method allows to produce longer and thicker nanofibers on a large scale. Additional components (such as polysaccharides, proteins, metallic nanoparticles and/or labels) can be added to the polymer-solvent blend to produce labelled composite-nanofibers. The nanoporous membrane can be cleaned with solvents and be re-used many times. The extrusion method allows to continuously produce nanofibers. Depending on the material (such as AAO) the pore diameter of the membrane can be easily controlled. The pore formation within the membrane is self-organized, simplifying the production process.

2. The mechanical properties of the composite material (crosslinking, thickness) are fully controllable by the choice of matrix, fibers and the printing parameters and process.

3. The orientation of the nanofibers is independently and locally controllable throughout the material. This allows to manufacture a composite material with locally independent mechanical properties.

A further, closely related aspect of the present invention relates to a composite material, in particular a composite material with locally independent mechanical properties which is obtainable by the methods of the present invention.

Typically, this composite material will comprise a polymer matrix and orientated nanofibers, wherein the nanofibers are oriented locally different in various areas of the composite material.

More specifically, the composite material is a multi-layered 3-dimensional composite material and the nanofibers are oriented locally different in various layers of the composite material and/or in various areas of one layer of the composite material.

### BRIEF DESCRIPTION OF THE FIGURES

FIG. 1: Extrusion of protein solution through a nanoporous AAO membrane. (A) Schematic drawing of the extrusion setup. (B) SEM image of AAO nanopores in top view. (C) Schematic cross-sectional view of protein solution (blue) being extruded through a single nanopores by applying pressure from the top.

FIG. 2 shows SEM images of nanofibers ECM protein structures, which were extruded with different parameters and deposited onto glass slides with either PLL or PFA coating: (A) collagen (PLL); (B) fibronectin (PLL); (C) fibrinogen (PFA); (D) elastin (PLL); (E) laminin (PFA); (F) collagen (PLL); (G) fibronectin (PFA); (H) Emerging collagen nanofibers from AAO nanopores membrane after extrusion (PFA); (I) Extruded bundle of fluorescently labelled fibrinogen nanofibers in PBS solution.

FIG. 3 shows the dependence of the nanofibers diameter from the AAO pore diameter and the protein concentration measured for collagen and fibronectin.

FIG. 4 shows SEM images of nanofibers assemblies of intracellular proteins, which were extruded with different parameters and deposited onto glass slides with either PLL or PFA coating: (A) actin (PLL); (B) 60 -actinin (PLL); (C) myosin (PFA); (D) actin (PLL)

FIG. 5 shows SEM images of protein composite nanofibers and polysaccharide nanofibers, which were extruded through pores with 200 nm diameter at a concentration of 10 μg/ml: (A) fiber bundle extruded from a collagen-fibronectin blend; (B) fiber assembly extruded from a collagen-elastin blend; (C) extruded nanofibers assembly of an actin-myosin blend; (D) nanofibers assembly of an extruded collagen-hyaluronan blend; (E) extruded nanofibers assembly of a collagen-chitosan blend; (F) assembly of extruded chondroitin sulphate nanofibers

FIG. 6: Scanning electron microscope image showing extruded chitosan nanofibers, which assembled into a micron-sized bundle, which reaches a length in the millimeter range.

FIG. 7: Chitosan fiber bundle with embedded iron oxide nanoparticles in an observation chamber with adjustable magnetic field.

FIG. 8: Schematic illustration of a 3D printing setup to locally and independently control the alignment of polysaccharide nanofibers using electric or magnetic fields.

The following non-limiting examples illustrate the present invention in more detail.

### EXAMPLE 1

### Preparation of Protein and Polysaccharide Nanofibers

Using AAO membranes, nanofibers from several different proteins, polysaccharides and a new variety of nanofibers protein composites could be reproducible extruded. The resulting nanostructures were characterised by scanning and transmission electron microscopy (SEM and TEM), atomic force microscopy (AFM) and confocal laser scanning microscopy.

1. Materials and Methods

1.1 Chemicals

Fibrinogen from human plasma was provided by Calbiochem (San Diego, Calif.) and fibrinogen from human plasma labelled with Alexa Fluor 647 was supplied by Life Technologies (Darmstadt, Germany). Collagen type I from calf skin, elastin from bovine neck ligament, laminin from Engelbreth-Holm-Swarm murine sarcoma basement membrane, chondroitin sulphate sodium salt from shark cartilage and hyaluronic acid sodium salt from Streptococcus equi were purchased from Sigma Aldrich (Munich, Germany). Albumin bovine Fraction V and paraformaldehyde were provided from Serva Electrophoresis GmbH (Heidelberg, Germany).

Phosphate buffered saline (PBS) tablets were provided from Life Technologies. Ethanol was purchased from Carl Roth. G-buffer with pH 7.5 was prepared from 2.0 mM Tris-HCl (Carl Roth, Karlsruhe, Germany), 0.2 mM CaCl₂ (Carl Roth), 0.2 mM Adenosine-5′-triphosphate.Na2-salt (ATP, Serva), 0.02% NaN₃(Alfa Aesar, Karlsruhe, Germany) and 0.2 mM Dithiothreitol (Serva). D-Buffer at pH 6.5 contained 0.6 mM KCl (Carl Roth) and 50 mM K₂HPO₄ (Carl Roth). A-buffer at pH 7.4 was prepared from 1 mM KHCO₃ (AppliChem, Darmstadt, Germany) and 0.02% NaN₃. Tris buffered saline solution (TBS) at pH 7.5 was prepared from 150 mM NaCl (Roth) and 50 mM Tris-HCl. All solutions were prepared with nanopure water from a TKA GenPure system (TKA, Germany).

1.2 Protein Purification

Fibronectin was purified from human plasma by gel filtration and affinity chromatography over a Sepharose CL-4B column (Sigma), followed by a gelatin Sepharose column from GE Healthcare (Munich, Germany). Subsequently, fibronectin was eluted by 6 M urea (Sigma) in PBS and dialyzed against PBS before use.

Actin was isolated from an acetone powder of rabbit skeletal muscle in G-buffer by modifying the protocol of Spudich and Watt (in Journal of Biological Chemistry 246, 4866 ff). Actin was polymerized by adding 50 mM KCl and 2 mM MgCl₂ (Carl Roth). Subsequently, KCl and MgCl₂ were removed by dialysis with G-buffer, and the depolymerized actin was purified by gel filtration with a Superdex 200 column (GE Healthcare). According to the protocol of Margossian and Lowey (in Methods in Enzymology 85, 55-71) also isolated was myosin II from rabbit skeletal muscle using centrifugation and salting out. The purified myosin was diluted in D-buffer.

α-actinin was isolated from chicken gizzard following the protocol of Craig et al. (in Methods in Enzymology 85,316-321). After extraction with 1 mM KHCO₃ α-actinin was salted out with (NH4)₂SO₄ (Carl Roth) and purified with ion exchange chromatography over a DEAE column (GE Healthcare) and gel filtration with a Superdex 200 column. Isolated α-actinin was stored in A-buffer.

1.3 Anodic Alumina Membranes

Nanoporous AAO membranes with pore diameters d_{AAO} of 21 and 450 nm were prepared by anodization in a home-built setup according to Raoufi et al. (in Langmuir 28, 10091-69). Both sides open anodic alumina membrane were obtained by removing the underlying aluminum substrate (in a solution containing 3.5 g of CuCl₂.H₂O (Alfa Aesar), 100 mL of HCl (37 wt %, Carl Roth), and 100 mL of H₂O) followed by chemical etching of the barrier layer (0.5 M aqueous phosphoric acid (Carl Roth) at 30° C.). Commercial Whatman® Anodisc membranes with a diameter of 200 nm were purchased from Sigma.

1.4 Extrusion of Nanofibers

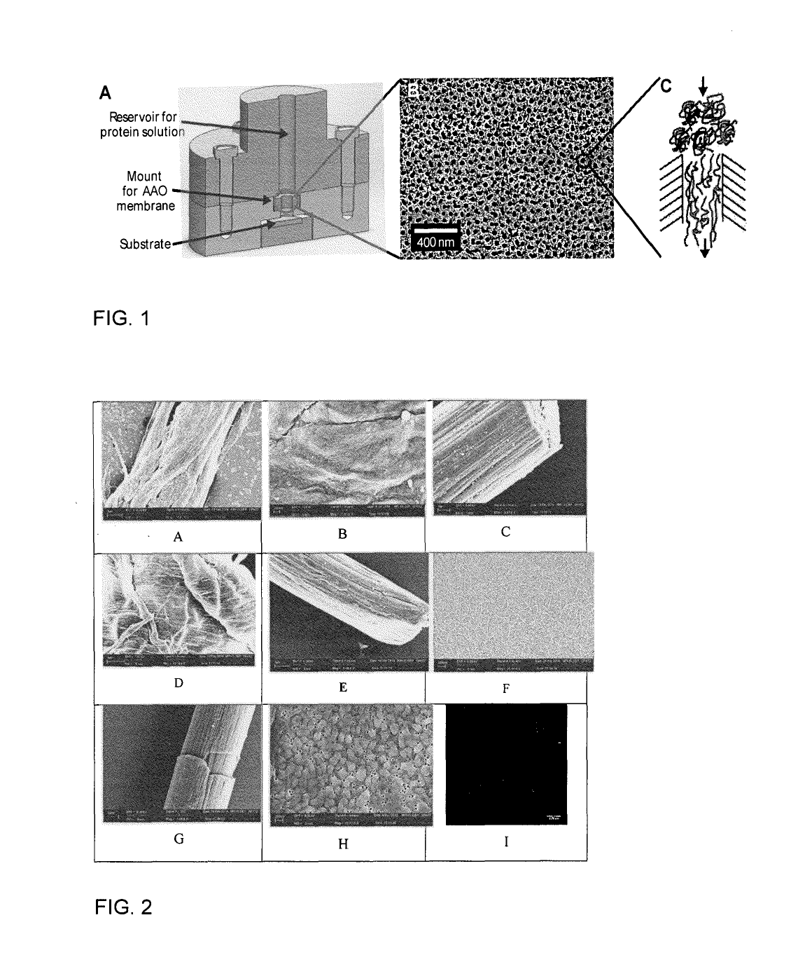

For the preparation of various nanofibers, a customized extrusion setup was designed (see FIG. 1). A syringe containing the feed solution was placed in the hollow cylinder of the upper part. The AAO membrane was mounted below the syringe and sealed with an O-ring. A glass substrate (Gerhard Menzel GmbH, Braunschweig, Germany) was cleaned with ethanol and nanopure water, dried with nitrogen and placed in the bottom holder directly under the AAO membrane to collect the extruded fibers. Then, the feed solution was manually injected through the AAO membrane. Protein and protein composite solutions were prepared in different buffers with varying concentrations according to Table 1. To prepare the resulting fibers for SEM analysis, they were collected on a glass, which was covered with 4% of the cross-linking agent PFA in PBS (pH 7.4). After 1 hour of incubation the fibers were rinsed with the respective buffer, followed by three rinsing steps with nanopure water and drying at room temperature. Fibers were also deposited onto glass slides, which were incubated with 1% (w/v) poly-L-lysine (PLL, Sigma) in H₂O for 10 minutes and subsequently dried with nitrogen. PLL-coated substrates were also used for the deposition of protein nanofibers in cell adhesion studies.

1.5 Microscopic Analysis and Cell Culture

After extrusion, the protein and composite fibers were coated with approximately 7 nm gold and analyzed with scanning electron microscopy (SEM) using a Zeiss Ultra 55cv device (Zeiss, Oberkochen, Germany). All measurements were performed with an operation voltage of 3 to 5 kV. The software Image J (1.44 p) was used to analyses the SEM images. The inventors statistically analyzed the average fiber diameter from at least 30 fibers and standard deviation as error.

Rat embryonic fibroblasts stably transfected with paxillin fused to yellow fluorescent protein (REF-YFP-paxillin) were a kind gift of Benjamin Geiger (Weizmann Institute of Science, Rehovot, Israel). REF-YFP-paxillin cells were maintained in Dulbecco's modified Eagle's medium (DMEM) supplemented with 10% fetal bovine serum (FBS), 2 mM L-glutamine and 100 units/ml penicillin-streptomycin (all from Gibco Laboratories, Eggenstein, Germany) at 37° C. and 5% CO2. Before seeding cells onto the protein nanofibers substrates, REF-YFP-paxillin cells were trypsinized with trypsin-EDTA 2.5% solution (Gibco Laboratories) for 3 min. Cells were seeded at a density of 5×105 per substrate in DMEM containing 1% FBS. Live cell phase contrast microscopy investigation was performed with 10 ×/0.25 Ph1 A-Plan objective (Zeiss, Jena, Germany) using an AxioVert 40 CFL microscope (Zeiss, Jena, Germany). To characterize focal adhesion formation 63×/1.25 Ph2 Plan Semi Apo Phase objectives (Zeiss, Jena, Germany) were used.

2. Results

The method of the present invention enabled to fabricate nanofibers from a large variety of biopolymers under physiological conditions. Nanoporous aluminum oxide templates were used to extrude various ECM and intracellular proteins as well as polysaccharides and composites thereof into nanofibers with different hierarchical assemblies.

2.1 ECM Proteins

Using the customized setup (compare FIG. 1) several ECM proteins were extruded to explore the possibility to fabricate biomimetic ECM nanofibers under physiological buffer conditions. Collagen type I, fibronectin and fibrinogen were prepared in PBS, elastin was diluted in 0.02 M Tris buffer at pH 8.8, and laminin was dissolved in TBS (see table 1). All proteins were concentrated at 10 μg/ml and extruded through nanopores with a diameter of 200 nm. Extrusion with this standard setting reproducibly yielded ECM protein nanofibers, which were deposited onto glass substrates with either PLL or PFA surface coating (see FIGS. 2a to 2e). SEM analysis of the extruded protein structures revealed that the nanofibers assembled into two different hierarchical structures. The average diameter of single ECM nanofibers in both hierarchical assemblies was in the range of 29 to 36 nm (see Table 1). It was observed that proteins, which were extruded onto glass slides with PLL coating, mostly formed expanded two-dimensional nanofibers assemblies without any long-range order (see FIG. 2a, 2b, 2d, 2f). When the protein solutions were extruded onto glass slides with PFA coating, primarily highly aligned nanofibers bundles with several micrometers in diameter (see FIG. 2c, 2e, 2g) were obtained. These nanofibers bundles often reached a length of several millimeters, which exceeds the previously reported length protein nanofibers prepared by pH-driven nanofibers assembly by several orders of magnitude (Maas et al. in Nano Let. 1, 1383-8). Based on the SEM analysis it can be assumed that the cross-linking agent PFA promotes the direct aggregation of protein nanofibers into bundles when they exit the AAO nanopores (see FIG. 2h).

The cross-linking of extruded protein nanofibers with PFA or other agents like carbodiimide or genipin could increase their mechanical properties, which can be beneficial for the development of novel durable biomaterials.

Furthermore, fluorescent fibrinogen labelled with Alexa 647 were extruded through 200 nm pores at a concentration of 10 μg/ml. In this extrusion, nanofibers with an average diameter of 34 nm were fabricated, which is in good agreement with the extrusion of unlabeled fibrinogen. The confocal microscopy image of a fluorescent fibrinogen fiber bundle in PBS solution shows that the fluorescent label was still functionally active after the protein solution was extruded into nanofibers (see FIG. 2i). In future, fluorescent protein labels could be used to study possible changes in the protein conformation, which occur during the extrusion process.

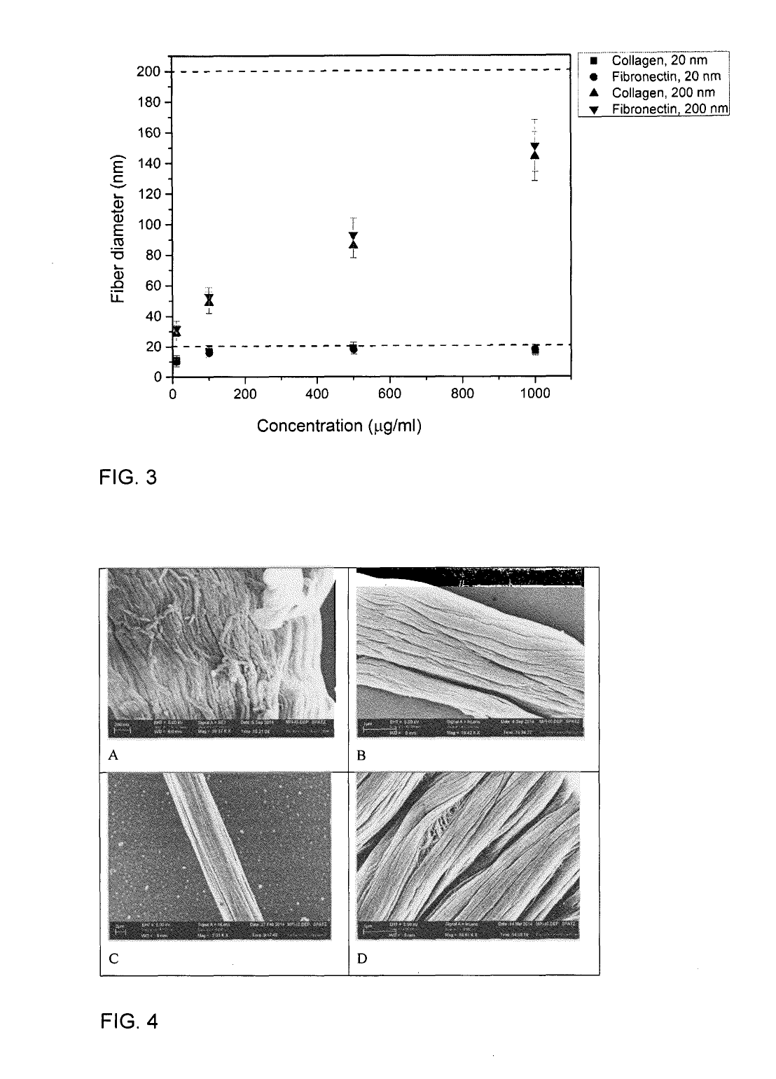

For collagen and fibronectin diluted in PBS, it was investigated how the diameter of extruded nanofibers depends on the concentration of the protein solution and the diameter of the nanoporous AAO membrane. Using pore diameters of 20 and 200 nm and varying the protein concentration between 10 and 1000 μg/ml it was possible to reproducibly control the nanofibers dimensions (see FIG. 3).

FIG. 3 shows the dependence of the nanofibers diameter from the AAO pore diameter and the protein concentration measured for collagen and fibronectin. The dashed lines indicate the two different nanopores diameters of 20 nm and 200 nm, respectively, which were used for the extrusion experiments with varying concentration of the protein solution.

For both collagen and fibronectin, it could be shown that the nanofibers diameter increased from approximately 10 nm at 10 μg/ml to 17 and 18 nm at 1000 μg/ml, respectively, when a pore diameter of 20 nm was used. With pore diameters of 200 nm the collagen and fibronectin fiber diameters increased from 29 and 32 nm at 10 μg/ml to 144 and 151 nm at 1000 μg/ml. Thus, for low protein concentrations the fiber diameter stayed below the diameter of the template nanopores and reached the dimension of the pore diameter when the protein concentration was increased.

These results clearly indicate that the diameter of extruded protein nanofibers can be tailored by adjusting the pore diameter and the protein concentration. In the novel extrusion approach the advantage of physiological buffers is combined with precise control of the nanofibers dimensions, which could not be achieved with the previously presented flow processing technique, which also utilized physiological solutions (Lai et al., in Regenerative Medicine 7, 649-691).

TABLE 1
Diameter of extruded ECM protein nanofibres in
different physiological buffers depending on AAO pore diameter
and protein concentration.

| Protein | Buffer | C (μg/ml) | D_{AAO} (nm) | D_{Fibre} (nm) |
|---|---|---|---|---|
| Collagen type I | PBS | 10 | 200 | 29 ± 5 |
| Fibronectin | PBS | 10 | 200 | 32 ± 5 |
| Fibrinogen | PBS | 10 | 200 | 34 ± 3 |
| Elastin | Tris | 10 | 200 | 36 ± 3 |
| Laminin | TBS | 10 | 200 | 35 ± 7 |
| Collagen type I | PBS | 10 | 20 | 11 ± 3 |
| Collagen type I | PBS | 100 | 20 | 17 ± 4 |
| Collagen type I | PBS | 100 | 200 | 49 ± 7 |
| Collagen type I | PBS | 500 | 20 | 19 ± 4 |
| Collagen type I | PBS | 500 | 200 | 86 ± 8 |
| Collagen type I | PBS | 1000 | 20 | 17 ± 3 |
| Collagen type I | PBS | 1000 | 200 | 144 ± 16 |
| Fibronectin | PBS | 10 | 20 | 10 ± 3 |
| Fibronectin | PBS | 100 | 20 | 16 ± 3 |
| Fibronectin | PBS | 100 | 200 | 53 ± 6 |
| Fibronectin | PBS | 500 | 20 | 18 ± 3 |
| Fibronectin | PBS | 500 | 200 | 93 ± 11 |
| Fibronectin | PBS | 1000 | 20 | 18 ± 3 |
| Fibronectin | PBS | 1000 | 200 | 151 ± 17 |

To assess the biocompatibility of extruded ECM proteins, the growth of REF-YFP-paxillin cells on nanofibers of collagen type I was studied. The nanofibers with an average diameter of 34±4 nm were deposited on glass slides with PLL coating and arranged into mesh-like mats as shown in FIG. 2f. In these preliminary cell culture studies the REF cells were found to attach well on the collagen nanofibers substrates. Fluorescence microscopy analysis revealed that YFP-labelled paxillin was recruited to the focal adhesion sites (data not shown).

These results indicate that nanofibers meshes of ECM proteins are biocompatible. The large-scale fabrication of nanofibers ECM protein assemblies could lead to a novel class of tissue engineering scaffolds with defined porosity and density. Furthermore, different hierarchical nanofibers assemblies with varying stiffness could be used to specifically control cell adhesion and alignment or to induce stem cell differentiation.

2.2 Intracellular Proteins

In its natural environment, the intracellular protein actin also assembles into filamentous structures, which are interconnected by α-actinin, thus forming the cellular cytoskeleton. The actin-based cell motility is driven by myosin, a molecular motor, which binds to the actin filaments and converts ATP into mechanical energy. Therefore, the present inventors have also analyzed the extrudability of these intracellular proteins to find out whether cellular protein fiber networks can be reconstructed with the new approach.

Actin was diluted in G-buffer, myosin II was prepared in D-buffer, and α-actinin was diluted in A-buffer. All proteins were extruded with the standard setting of 200 nm pore diameter and a protein concentration of 10 μg/ml. This process reproducibly yielded nanofibers assemblies with average diameters of single nanofibers ranging from 31 to 37 nm (see FIG. 4 and Table 2 below). This diameter range of intracellular protein nanofibers conforms well to the above shown diameters of ECM protein fibers.

For actin, extrusions through 200 nm pores with 100 μg/ml were also performed, which yielded a fiber diameter of 64±6 nm (see FIG. 4d). When 10 μg/ml actin solution were extruded through 20 nm large pores, the resulting nanofibers had a diameter of 15±3 nm and were several micrometers long. These dimensions are close to natural actin filaments, which are in the range of 7 nm and several micrometers long. Thus, extruded intracellular protein nanofibers could be a useful tool in mechanobiological studies, as they were previously performed, for instance using micropipettes or optical tweezers.

With the extrusion process the dimensions as well as the buffer conditions can be well controlled to mimic the natural environment of intracellular proteins more closely.

FIG. 4 shows SEM images of nanofibers assemblies of intracellular proteins, which were extruded with different parameters and deposited onto glass slides with either PLL or PFA coating: (A) actin (c=10 μg/ml, d_{AAO} nm, PLL) (B) α-actinin (c=10 μg/ml, d_{AAO}=200 nm, PLL), (C) myosin (c=10 μg/ml, d_{AAO}=200 nm, PFA), (D) actin (c=100 μg/ml, d_{AAO}=200 nm, PLL).

TABLE 2
Diameter of extruded intracellular protein nanofibres
in different physiological buffers depending on AAO pore
diameter and protein

| Protein | Buffer | C (μg/ml) | D_{AAO} (nm) | D_{Fibre} (nm) |
|---|---|---|---|---|
| Actin | G-buffer | 10 | 200 | 37 ± 8 |
| Actin | G-buffer | 100 | 200 | 64 ± 6 |
| Actin | G-buffer | 10 | 20 | 15 ± 3 |
| Myosin II | D-buffer | 10 | 200 | 33 ± 5 |
| α-actinin | A-buffer | 10 | 200 | 39 ± 7 |

2.3 Protein Composites

The natural ECM consists of nanofibers from various ECM proteins, which are surrounded by an aqueous solution of long-chain polysaccharides, such as hyaluronan and chondroitin sulphate. To design novel biomaterials, which mimic the natural cellular environment more closely, the present inventors also prepared nanofibers composites from different ECM proteins and ECM proteins blended with polysaccharides. Furthermore, it was possible to extrude blended solutions of intracellular proteins and pure polysaccharides into nanofibers composites. All solutions were extruded with a total protein or blend concentration of 10 μg/ml using 200 nm large pores and the physiological buffers listed in Table 3. Thus, different nanofibers arrangements with single fiber diameters ranging from 28 to 38 nm were obtained.

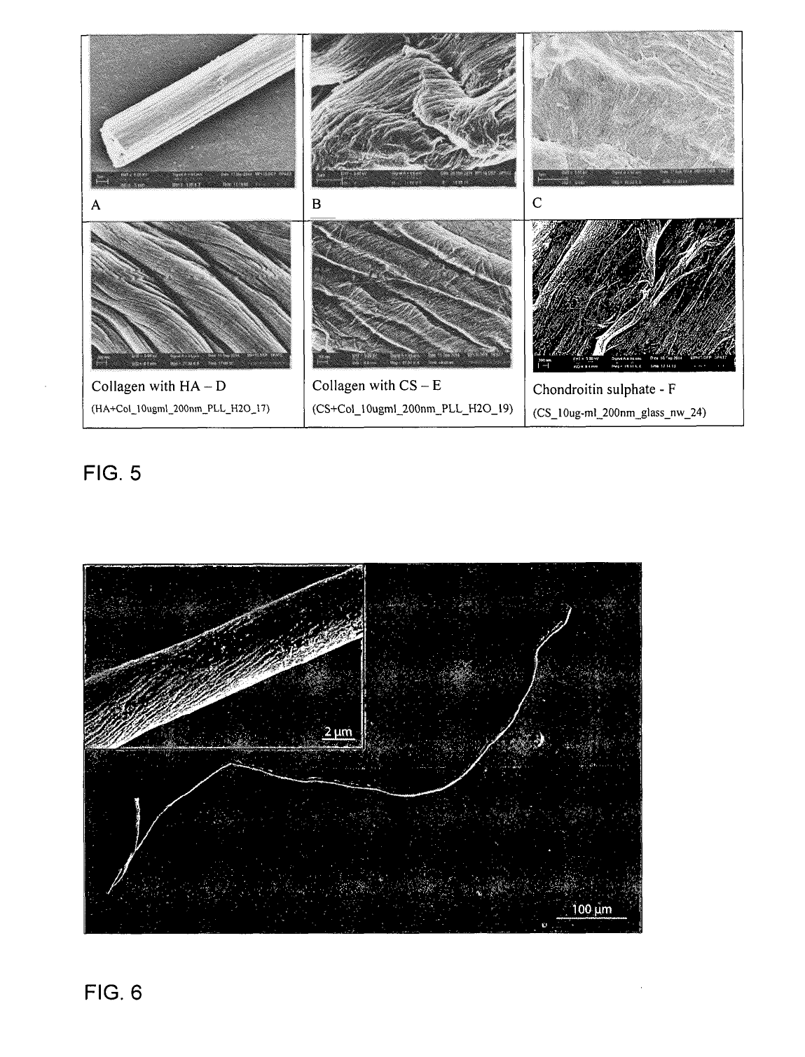

A blend of collagen and fibronectin was successfully extruded into micron-sized bundles of blended nanofibers (see FIG. 5a). When collagen and elastin was mixed and extruded a nanofibers assembly (shown in FIG. 5b) was obtained, which strongly resembled the natural structure of explanted rat Achilles tendon sheaths.

The inventors also blended collagen with the polysaccharides hyaluronan and chondroitin sulphate, respectively, and were able to extrude composite nanofibers, which were assembled into expanded assemblies (FIGS. 5c and 5d). The extrudability of both polysaccharides on their own was also tested and the inventors were able to produce pure sugar nanofibers from both of them for the first time. An exemplary assembly of chondroitin sulphate nanofibers is shown in FIG. 5e.

Such nanofibers composites containing different ECM proteins and/or polysaccharides could find application as tailored tissue engineering scaffolds which closely mimic a specific tissue in vitro.

Furthermore, extruding a blend of the intracellular proteins actin and myosin with the standard setting yielded 2-dimensional arrangements of nanofibers (se FIG. 5f). Such assemblies of intracellular protein nanofibers could be used as model system to study intracellular networks of filamentous and motor proteins, for instance in the presence of ATP gradients and/or actin-binding proteins like α-actinin.

FIG. 5 shows SEM images of protein composite nanofibers and polysaccharide nanofibers, which were extruded through pores with 200 nm diameter at a concentration of 10 μg/ml: (A) fiber bundle extruded from a collagen-fibronectin blend, (B) fiber assembly extruded from a collagen-elastin blend, (C) extruded nanofibers assembly of an actin-myosin blend, (D) nanofibers assembly of an extruded collagen-hyaluronan blend, (E) extruded nanofibers assembly of a collagen-chitosan blend (F) assembly of extruded chondroitin sulphate nanofibers.

TABLE 3
Diameter of protein composite nanofibers and
polysaccharide nanofibers in varying buffers, which were
extruded through nanopores with 200 nm diameter at a
concentration of 10 μg/ml.

| | | C | D_{AAO} | D_{Fibre} |
|---|---|---|---|---|
| Composite | Buffer | (μg/ml) | (nm) | (nm) |
| Protein/Protein: | | | | |
| Collagen/ | PBS | 10 | 200 | 32 ± 6 |
| Fibronectin | | | | |
| Collagen/Elastin | Tris/PBS (1:1) | 10 | 200 | 38 ± 4 |
| Myosin/Actin | G-buffer/D-buffer | 10 | 200 | 35 ± 7 |
| | (1:1) | | | |
| Protein/Polysaccharide: | | | | |
| Collagen/Chondroitin | PBS | 10 | 200 | 33 ± 5 |
| sulphate | | | | |
| Collagen/Hyaluronan | PBS | 10 | 200 | 37 ± 5 |
| Polysaccharide: | | | | |
| Chondroitin sulphate | PBS | 10 | 200 | 28 ± 4 |
| Hyaluronan | PBS | 10 | 200 | 33 ± 8 |

Summarizing, it was possible to fabricate nanofibers of various biopolymers, including polysaccharide fibers as well as protein fibrils made of, e.g., fibronectin, fg, actin, collagen, myosin, BSA, α-actinin and laminin. The same principal approach is applicable for different type of polymers with different concentrations in different buffers.

The precise control over nanofibers geometry and alignment which is possible with this approach is advantageous for a wide range of applications in nanofabrication and tissue engineering. In an especially advantageous application, these nanofibers can be further processed to fabricate novel composite materials with improved properties as described above and in Example 2.

### EXAMPLE 2

### Preparation of a Composite Material Comprising Orientated Nanofibers

A composite material with locally controlled mechanical properties (which may mimic the 3D orientation of chitin fibers found within natural arthropod cuticle) can be prepared from mixtures of chitosan nanofibers bundles in a polylactide matrix.

The nanofibers and nanofibers bundles can be prepared using the methods described above. Chitosan (Sigma Aldrich, no. 448877) with a concentration of 1 mg/ml is dissolved under permanent stirring in acetic acid (1%) over a period of 24 h. The chitosan-acid mixture is extruded through an AAO membrane with a pore diameter of 200 nm. The nanofibers-solvent mixture is carefully centrifuged at low speeds to sediment the fibers. PLA powder is melted (approx. 210° C), mixed with the sedimented fibers and pressed into a filament form, compatible with a commercially available 3D printer (such as Makerbot Replicator, 1.75 mm filament diameter). The printer is equipped with a custom-designed printing head, including a temperature-controlled nozzle and perpendicularly orientated electrodes. A customized printing software is used to generate printing code, compatible with the customized printer. The code includes standard printing information (x,y,z position of the printing nozzle, filament extrusion and nozzle temperature) as well as the orientation and strength of an electric field. The filament is loaded into the printing nozzle and heated up. Once the filament is melted within the nozzle, the electric field and the dipole moment of the chitosan fibers are used to orientate the fibers. The melted, oriented filament is then printed layer by layer onto a desired substrate. When cooling down, the filament orientation within the printed filament is preserved.

### EXAMPLE 3

### Preparation of a Composite Material Comprising Chitosan Nanofibers with Embedded Magnetic Nanoparticles

Nanofibers with embedded iron oxide nanoparticles can be prepared by extrusion to facilitate fiber orientation in an external magnetic field.

The nanofibers and nanofibers bundles were prepared using the methods described above. Chitosan (Sigma Aldrich, no. 448877) with a concentration of 0.5 mg/ml was dissolved under permanent stirring in acetic acid (1%) over a period of 24 h.

Iron oxide nanoparticles with a diameter between 10 and 50 nm were added to the acidic chitosan solution with a final concentration of 0.1 mg/ml. This composite solution was extruded through an AAO membrane with a pore diameter of 200 nm using a constant flow rate of 500 μl/min.

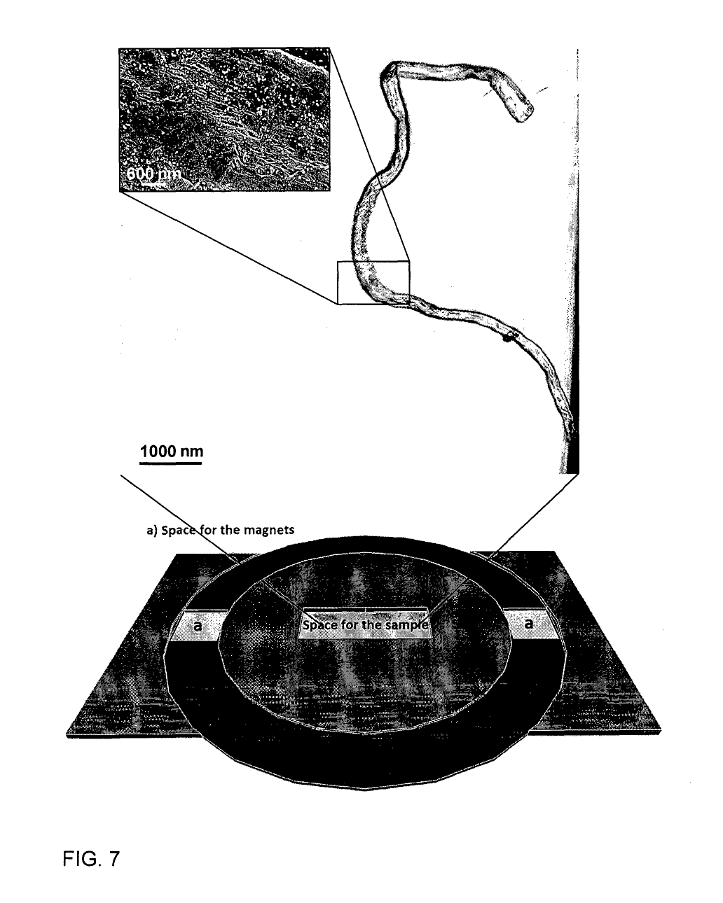

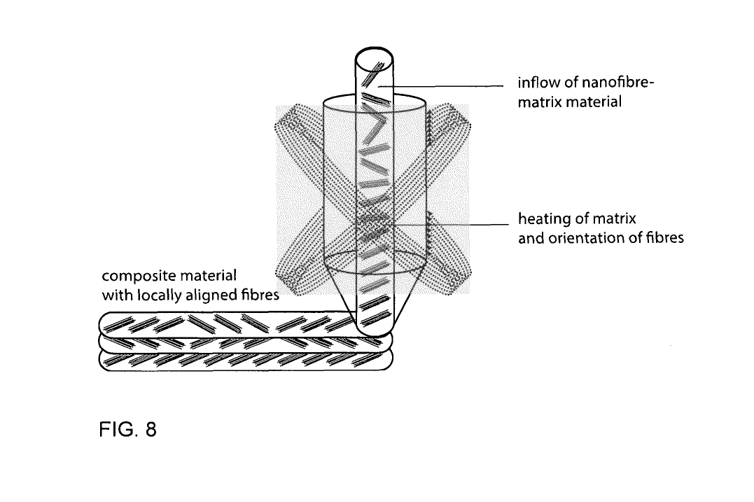

The extruded fibers with embedded particles were placed in a custom-built observation chamber with adjustable magnetic field (see FIG. 7). The fibers and their orientation in the surrounding medium were visualized in dependence of the strength and orientation of the magnetic field using optical light microscopy.

1. A method for preparing nanofibers comprising:
providing a nanoporous material;
dissolving a natural or synthetic polymer in a solvent; and
pressing or drawing the polymer solution through pores of the nanoporous material whereby nanofibers are formed within said material.

2. The method according to claim 1, wherein the polymer is a protein or polysaccharide.

3. The method according to claim 1, wherein the polymer is selected from the group comprising fibronectin, elastin, fibrinogen, collagen, myosin, actin, BSA, α-actinin, laminin, chondroitin sulfate, hyaluronan, chitin-derivatives and mixtures thereof.

4. The method according to claim 1, wherein the nanoporous material is a membrane, in particular an anodic aluminum oxide membrane (AAO), titanium dioxide, silicone dioxide, polycarbonate (PCTE), or a zeolite.

5. The method according to claim 1, wherein the nanoporous material has a mean pore size in a range from 4 nm to 900 nm, and a thickness in a range from 10 μm to 100 μm.

6. The method according to claim 1, wherein the nanofibers have a length in a range from 100 nm to several millimeters, and a diameter between typically 5 nm and 500 nm, and bundles of nanofibers suitable for preparing a nanofibers-containing composite material typically have a length in a range from 100 nm to several millimeters.

7. A method for preparing a nanofibers-containing composite material comprising:
providing nanofibers by preparing the nanofibers according to claim 1;
mixing the nanofibers with a matrix material; and
orientating or partially orientating the nanofibers within the matrix material by applying an electric and/or magnetic field.

8. The method according to claim 7, wherein the matrix material is selected from the group comprising polylactic acid (PLA), poly(lactic-co-glycolic acid) (PGLA), polyethylene glycol (PEG), polyethylene oxide (PEO), acrylnitril-butadien-styrol (ABS), polyvinyl pyrrolidone (PVP), polyvinyl alcohol (PVA), polycarbonate (PC), nylon, acrylnitril-styrol-acrylester (ASA), and silicone.

9. The method according to claim 8, further comprising:
depositing the nanofibers-matrix mixture with the orientated or partially orientated nanofibers onto a substrate surface; and
curing and/or crosslinking the deposited nanofibers-matrix mixture for preserving the structure of the nanofibers-containing composite material.

10. The method according to claim 9, wherein the deposition of the nanofibers-matrix mixture onto the substrate surface is affected by a nozzle of a printing device.

11. The method according to claim 7, wherein the nanofibers are oriented locally different in various areas of the composite material resulting in the composite material having locally independent mechanical properties.

12. The method according to claim 11, further comprising printing the composite material as a multi-layered 3-dimensional composite material layer by layer onto a substrate surface, wherein the nanofibers are oriented locally different in various layers of the composite material and/or in various areas of one layer of the composite material.

13. The method according to claim 7, comprising:
providing a nanoporous material;
dissolving a natural or synthetic polymer in a solvent;
pressing or drawing the polymer solution through pores of the nanoporous material whereby nanofibers are formed within said material;
separating the nanofibers from the solvent;
mixing the nanofibers with a matrix material;
orientating or partially orientating the nanofibers within the matrix material by applying an electric and/or magnetic field; and
depositing the nanofibers-matrix mixture with the orientated or partially orientated nanofibers onto a substrate surface, whereby a nanofibers-containing composite material is obtained and wherein the nanofibers are oriented locally different in various areas of the composite material, resulting in the composite material having locally independent mechanical properties.

14. The method according to claim 13, wherein
the depositing comprises printing the composite material as a multi-layered 3-dimensional composite material layer by layer onto a substrate surface; and
the nanofibers are oriented locally different in various layers of the composite material and/or in various areas of one layer of the composite material.

15. The method according to claim 7, further comprising heating the nanofibers-matrix mixture before and/or during the orientating or partial orientating of the nanofibers.

16. The method according to claim 7, wherein the nanofibers and/or the nanofibers-matrix mixture comprise additives which are capable to promote the orientating or partially orientating of the nanofibers by the applied electric or magnetic field.

17. The method according to claim 9, further comprising moving the substrate during the deposition process.

18. A composite material comprising a polymer matrix material and orientated nanofibers, wherein the nanofibers are oriented locally different in various areas of the composite material.

19. The composite material according to claim 18 wherein the composite material is a multi-layered 3-dimensional composite material and nanofibers or nanofibers bundles are oriented locally different in various layers of the composite material and/or in various areas of one layer of the composite material.

20. The composite material according to claim 19 which is obtained by depositing a nanofibers-matrix mixture, comprising the nanofibers and the matrix material, onto a substrate surface layer by layer.
